(19) United States
(12) Patent Application Publication
(10) Pub. No.: US 2003/0182324 A1
(43) Pub. Date: Sep. 25, 2003

(54) Information providing system

(75) Inventors: Hiroshi Satomi, Kanagawa (JP); Satoshi Igeta, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/385,853

(22) Filed: Mar. 12, 2003

(30) Foreign Application Priority Data
Mar. 19, 2002 (JP) 2002-076761
Mar. 19, 2002 (JP) 2002-077071

(51) Int. Cl. G06F 12/00

(52) U.S. Cl. 707/203

(57) ABSTRACT

Disclosed is an information providing system for disclosing images by an Internet photo site. Disclosure of the images by the Internet photo site is reported to a third party allowed to view the images. If a change is made to a setting regarding viewing after the images have been disclosed, the third party for which the notification setting has been made is notified of the change of the setting regarding viewing.

### FIELD OF THE INVENTION

This invention relates to an information providing system for disclosing data by an information providing apparatus on a network.

### BACKGROUND OF THE INVENTION

An information providing service utilizing the Internet has become possible in recent years thanks to the building of communications infrastructure and the development of information communication technology.

Further, owing to the progress being made in producing ever smaller semiconductor devices and the reduction in component size and cost of LSI chips and solid-state image sensors that constitute image input devices typified by digital still cameras and digital video cameras, larger numbers of users now take photographs using these image input devices and obtain digital image data.

For example, after digital image data captured by a user employing a digital still camera is stored in a memory within the camera, the user may preserve the image data by transferring it to a storage device typified by a hard-disk drive in a personal computer possessed by the user, or the user may archive the image data by writing it to an external recording medium such as a CD-R.

Further, the popularization of color scanners has made it easy for users to create and archive images, which have been read using a color scanner, as digital image data.

With this as a background, one type of information providing service utilizing the Internet is a network service through which digital image data that a user has captured using an image input device is kept in a storage area of a server on the Internet and can be viewed whenever the user so desires. Another available network service makes it possible for the user to disclose entrusted digital image data to a third party that desires the image data.

An Internet service provider that provides such a network service shall be referred to as a “photo site” below.

When a user discloses digital image data to a third party at a photo site, there are many cases where the above service is provided by notifying the third party, via E-mail, of the method of viewing the disclosed digital images and of any comments entered by the user. The third party views the digital images using access means described in the E-mail received.

However, there are cases where digital image data, once it has already been reported and disclosed, is deleted by the user or made private by the user through a change of the view setting. If a third party attempts to view these digital images in such case, it will fail because the digital image data will have been deleted or made private.

If a third party that was notified of disclosure in the past by the user of the photo site can be re-notified to the effect that the digital images have been deleted or made private, then the third party can be made aware of the fact the digital images are no longer viewable. In this case, however, the user must remember all of the third parties that were informed of disclosure. If the number of such third parties is large, a very heavy burden is imposed upon the user.

### SUMMARY OF THE INVENTION

Accordingly, an object of the present invention is to provide an information providing system, an information providing apparatus, an information providing method, a program and a recording medium which, when notification of disclosure of data is given, enable a user to designate whether or not a plurality of third parties allowed to view the data are to be notified of a change in viewing made after disclosure, thereby making it possible to notify the plurality of third parties reliably of the change in viewing.

According to the present invention, the foregoing object is attained by providing an information providing system for providing a service for storing data and disclosing the stored data on a network by using a plurality of information processing apparatuses, the system including the plurality of information apparatuses, the system comprising:

first notification means for notifying designated external communication terminals of the fact that disclosure of the stored data is possible;

determination means for determining whether or not to notify the designated external communication terminals of a change if the data has been changed or a setting of disclosing the data has been changed after notification by the first notification means;

detection means for detecting whether or not the data has been changed or the setting of disclosing the data has been changed; and

second notification means for notifying the designated external communication terminals of the change in accordance with determination of the notification by the determination means and detection of the change by the detection means.

Further, according to the present invention, the foregoing object is attained by providing an information providing method of providing a service for storing data and disclosing the stored data on a network, the method being implemented by the plurality of information processing apparatuses, the method comprising:

a first notification step of notifying designated external communication terminals of the fact that disclosure of the stored data is possible;

a determination step of determining whether or not to notify the designated external communication terminals of a change if the data has been changed or a setting of disclosing the data has been changed after notification of the change;

a detection step of detecting whether or not the data has been changed or the setting of disclosing the data has been changed; and

a second notification step of notifying the designated external communication terminals of the change in accordance with determination of the notification and detection of the change.

Further, according to the present invention, the foregoing object is attained by providing an information providing apparatus for providing a service for storing data and disclosing the stored data on a network, comprising:

first notification means for notifying designated external communication terminals of the fact that disclosure of the stored data is possible;

determination means for determining whether or not to notify the designated external communication terminals of a change if the data has been changed or a setting of disclosing the data has been changed after notification of the change by the first notification means;

detection means for detecting whether or not the data has been changed or the setting of disclosing the data has been changed; and

second notification means for notifying the designated external communication terminals of the change in accordance with determination of the notification by the determination means and detection of the change by the detection means.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram illustrating an example of the configuration of an information providing system according to an embodiment of the present invention;

FIG. 2 is a diagram illustrating an input screen for giving notification of a viewing method according to this embodiment;

FIG. 3 is a diagram illustrating the composition of an album notification destination table according to this embodiment;

FIG. 4 is a flowchart of processing for transmitting notification mail according to this embodiment;

FIG. 5 is a flowchart of error-mail processing according to this embodiment;

FIG. 6 is a diagram illustrating a screen for verifying album deletion;

FIG. 7 is a flowchart of album deletion processing according to this embodiment;

FIG. 8 is a diagram illustrating mail that notifies of album deletion according to this embodiment;

FIG. 9 is a flowchart of mail notification processing according to this embodiment;

FIG. 10 is a diagram illustrating a screen of album properties according to this embodiment;

FIG. 11 is a diagram illustrating mail that notifies of album disclosure termination according to this embodiment;

FIG. 12 is a diagram illustrating mail that notifies of album re-disclosure according to this embodiment;

FIG. 13 is a diagram illustrating an input screen for giving notification of a viewing method according to a modification of this embodiment; and

FIG. 14 is a flowchart of processing for transmitting notification mail according to the modification.

### DETAILED DESCRIPTION OF THE PREFERRED EMBODIMENT

An embodiment of the present invention will now be described in detail with reference to the drawings. It should be noted that the relative arrangement of the components and the display screens, etc., set forth in this embodiments do not limit the scope of the present invention unless it is specifically stated otherwise. The scope of the present invention is not limited to this arrangement of components and display screens.

An information providing system for sharing and providing digital image data via the Internet will be described as an embodiment of the invention.

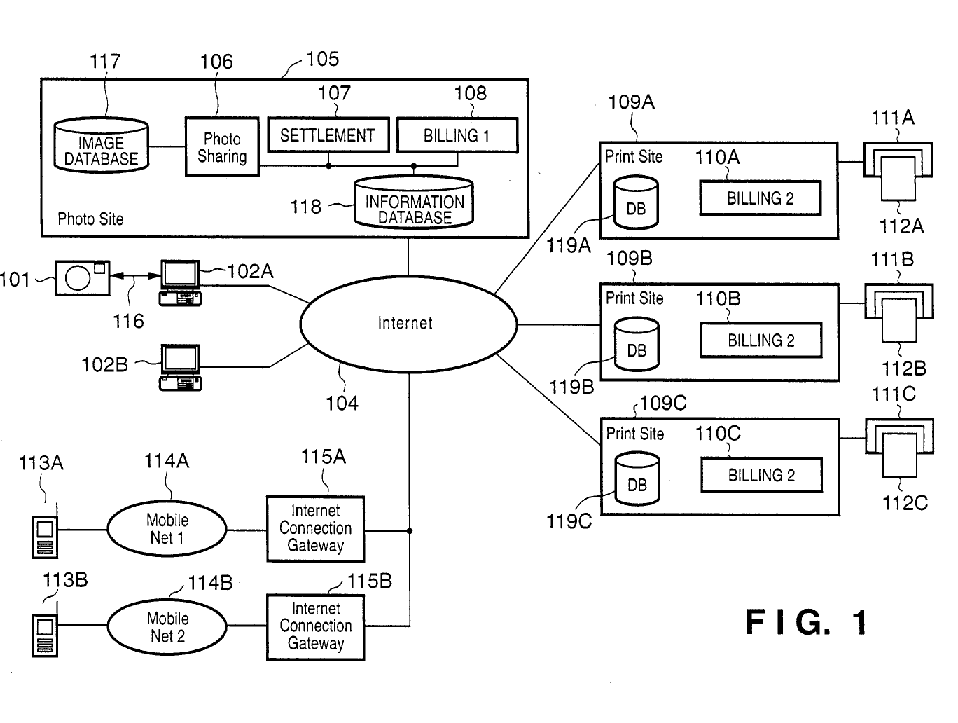

FIG. 1 is a diagram illustrating an information providing system according to this embodiment.

As shown in FIG. 1, the system includes an image input unit 101, such as a digital still camera capable of taking still pictures and recording these as digital image data, and a digital video camera capable of taking moving pictures and recording these as moving image data. The device converts an optical image, which is image information, to an electrical signal, subjects the signal to prescribed image processing and records or plays back the signal as digital information. The system further includes a user personal computer (referred to as the “user PC” below) 102A, and a data transfer interface 116 for transferring captured image data between the image input unit 101 and user PC 102A. The data transfer interface 116 may be a wired interface typified by, e.g., USE, IEEE1394, or a wireless interface typified by, e.g., IrDA, Bluetooth, etc.

The image data captured by the image input device 101 and stored as digital information in an information storage device of the image input unit 101 is transferred to a storage area of an information storage device typified by a hard-disk drive of the user PC 102A. With regard to the transfer of image data from the image input unit 101 to the user PC 102A, there are cases where the image data that has been stored in the information storage device of the image input unit 101 is transferred collectively in response to an instruction from an operating system or special-purpose software that has been installed in the user PC 102A, and cases where the operating system of the user PC 102A or special-purpose software reserve a storage area in the information storage device of the user PC 102A and transfer the image data in response to a transfer command sent from the image input unit 101.

Image data thus transferred to the user PC 102A is uploaded to a photo site 105, which is connected over the Internet 104, by a procedure described below.

A browser operable at the user PC 102A and having a standard protocol for information transfer over the Internet 104 accesses the photo site 105 using a standard protocol such as the HTTP protocol, and displays information linked to multimedia information such as images and voice created by a description language such as HTML or XML managed by the server PC of the photo site 105.

This operation makes it possible for the user PC 102A to receive a service, which utilizes the Internet 104, as a communication service provided by the photo site 105.

Next, the image data captured by the image input unit 101 and stored in the information storage area of the user PC 102A is transferred to the photo site 105 in response to a request from the user of the user PC 102A. (This transfer shall be referred to as “image upload”.) Image upload can involve selecting image data, which is desired to be transferred, from the aforesaid browser and then transferring the data in operative association with an action requesting image upload, or selecting image data using dedicated software for image upload and transferring the data directly from this dedicated software. In either case, upload is executed based upon an HTTP or FTP protocol utilizable over the Internet.

The module for executing this series of operations at the photo site 105 is a photo sharing module 106. The latter checks to determine whether uploaded image data is image data that is usable at the photo site 105 and, if it is determined that the image data is usable, stores the uploaded image data in an image database 117 and stores the attribute information thereof in a database 118. At this stage the photo sharing module 106 notifies the user PC 102A of the fact that the image data has been uploaded normally.

Besides the attribute information of the image data, data of user attribute information that has been registered at the photo site 105 and various data such as attribute information of a print-server provider (referred to as a “print site” below) that requests printout of the uploaded image data also is stored in the database 118 and this data is managed in centralized fashion.

Thus, the user of the user PC 102A is capable of viewing an uploaded image by designating it via the browser. It should be noted that there are also cases where viewing can involve dealing with a plurality of uploaded images collectively as a single unit and managing them as an album.

The flow of processing when printing of uploaded image data is ordered will now be described in sequence. Among the images that have been uploaded to the photo site 105, the user of the user PC 102A is capable of viewing the images, which the user him/herself uploaded, via the browser. There are two ways to select images to be viewed. One is to select images sequentially one image at a time, and the other is to register a plurality of images as a single album, select an album, which the user wishes to view, from a group of a plurality of albums and select and view individual images managed as the selected album.

An order from the user to print an uploaded image is sent to the print site, which provides a printout of the image as a solution. Print sites are sites provided by the print provider and are indicated at 109A, 109B and 109C in FIG. 1. Though only three print sites are shown in FIG. 1 for reasons of convenience, more may be provided and the number is not limited to three.

The user of the user PC 102A selects an image, which is desired to be printed out as the final product, from a screen that is for viewing uploaded images. Next, from among the print sites 109A, 109B, 109C provided by the photo site 105, the user of the user PC 102A selects the print site to which the user wishes to place the order. Here the user selects the desired print site upon taking into consideration the services, prices and delivery times, etc., provided by each of the print sites.

For the sake of simplicity, the description rendered below will assume that the user has selected print site 109A. However, the basic flow of information is the same even if the print site selected by the user is print site 109B or 109C.

First, the user wishing to order printout selects the image desired to be printed and the print site from the viewing screen and notifies the photo site 105. The photo site 105, on the other hand, generates a provisional print order relating to the image requested for printout and requests the selected print site 109A for an estimate via the Internet 104.

Upon receiving the provisional order from the photo site 105, the print site 109A calculates the price from the content of the provisional order by a first billing module 110A, which serves as billing means, and reports the estimated price to the photo site 105 via the Internet 104. The photo site 105 receives the information relating to the estimated price in real time, transfers this to the user PC 102A as information and can dynamically present the user that ordered printout with the price offered by the print site 109A.

The user of the user PC 102A that ordered printout checks the price presented. If the user decides to make the purchase at this price, then the user replies to the photo site 105 in the affirmative. A settlement module 107 serving as settlement means accepts this reply and executes settlement. At the stage where settlement is concluded, the photo site 105 sends a formal print order to the print site 109A. The latter accepts the formal print order and acquires the image data necessary for printout from the image database 117 of the photo site 105.

The image represented by the image data thus acquired is printed out by a printer 111A serving as printing means possessed by the print site 109A, whereby the image is output as a print 112A. The print 112A obtained by printout is sent by transport means such as postal mail to a delivery destination specified by the user of the user PC 102A that requested printout.

The foregoing is an overview of a system in which a user who has uploaded image data, captured by the image input unit 101, via the user PC 102A browses the photo site 105 and orders the printing of desired images.

The system has been described taking a personal computer as an example of the terminal that uploads the images. However, the information providing system according to the present invention is not limited to this arrangement. Images may be uploaded from a portable terminal, and images may be uploaded directly from an image input unit such as a digital still camera, digital video camera, scanner or digital copier.

Described next will be a method whereby a third party, namely a party other than a user that uploaded image data to the photo site 105 on the Internet 104, views images represented by image data that has been stored in the image database 117 of the photo site 105.

Here it is assumed that the photo site 105 provides a third party, who has been specified by the user that uploaded the image data, with a service for viewing and ordering printout of uploaded images or an album in which a plurality of uploaded images are managed as one archive.

First, the user that uploaded the image data to the photo site 105 notifies the photo site 105, by way of a Web browser, of attribute information, such as the name of the third party (referred to as a “viewing user” below) allowed to view images by the uploading user, and of the E-mail (referred to simply as “mail” below) address of this third party. In response, the photo site 105 first generates the URL (Universal Resource Locator), which is necessary for disclosure, if an image is to be disclosed to the viewing user. The URL generated at this time is a unique address. The address assigned is one, such as a random number, that cannot be predicted. The following is one example:

http://OOO.com/PhotoSite/Album/AlbumEntry.cgi?AlbumID=AJNWDMF

This unpredictable URL shall be referred to as a “random URL”.

The photo site 105 reports the random URL thus generated to the viewing user upon appending password information, which is required for viewing, as necessary. The random URL is reported by mail via the Internet 104. Upon receiving the mail, the viewing user accesses the Internet 104 from a user PC 102B and enters the random URL, of which notification has been given by mail, to the Web browser, whereby the viewing user can view an image or album specified by the user that uploaded the image data.

Described next will be a method whereby the viewing user employing the user PC 102B orders printout of images thus capable of being viewed. The photo site 105 directs an image print order from the viewing user to any of the print sites 109A, 109B, 109C that provide printout of images represented by image data.

First, the viewing user employing the user PC 102B uses the viewing screen of the above-mentioned Web browser to select an image desired to be printed out and acquired as a print. The viewing user of the user PC 102B then selects the print site, from among the print sites 109A, 109B, 109C provided by the photo site 105, to which the viewing user wishes to place the order. The viewing user selects the desired print site upon taking into consideration the services, prices and delivery times, etc., provided by each of the print sites.

For the sake of simplicity, the description rendered below will assume that the viewing user has selected print site 109B. However, the basic flow of information is the same even if the print site selected by the viewing user is print site 109A or 109C.

First, using the viewing screen, the viewing user selects the image for which printout is desired and notifies the photo site 105, whereupon the photo site 105 generates a provisional print order relating to the image requested for printout and transmits the provisional order data via the Internet 104, thereby requesting the print site 109B for an estimate. Upon receiving the provisional order from the photo site 105, the print site 109B acquires image data necessary for the selection image information from the image database 117 of photo site 105 and generates the selection image information. The print site 109B transmits the selection image information to the user PC 102B via the Internet 104, whereby the viewing user is capable of entering the print format and number of prints of every selected image using the Web browser at the user PC 102B.

On the basis of information such as the print format and number of printed for each selected image, the print site 109B calculates an estimate by a second billing module 110B and transmits the calculated estimate to the photo site 105 via the Internet 104. The photo site 105 receives the information relating to the estimated price, which is transmitted from the print site 109B, in real time. If the viewing user is one not possessing the personal information of the user, the estimate that has been transmitted from the print site 109B is transferred to the user PC 102B as Web information. If the viewing user is one possessing the personal information of the user, then a presentation price obtained by adding points to the estimate is transferred as Web information and this can be presented dynamically to the viewing user that ordered printout.

The user of the viewing user PC 102B that ordered printout checks the price presented. If the viewing user decides to make the purchase at this price, then the viewing user replies to the photo site 105 in the affirmative. The settlement module 107 serving as settlement means accepts this reply and executes settlement. At the stage where settlement is concluded, the photo site 105 sends a formal print order to the print site 109B. The latter accepts the formal print order and acquires the image data necessary for printout from the image database 117 of the photo site 105.

The image represented by the image data thus acquired is printed out by a printer 111B serving as printing means possessed by the print site 109B, whereby the image is output as a print 112B. The print 112B obtained by printout is sent by transport means such as postal mail to a delivery destination specified by the user of the user PC 102B that requested printout.

The photo site 105 is also capable of providing the owner of a portable terminal specified by the user that uploaded images with notification of image (or album) viewing, a viewing function and a service for ordering prints. As a result, the portable terminal can receive notification mail that includes an URL for viewing an image or album, and the portable terminal can similarly view or order the printing of an image or album. (A user who utilizes the photo site 105 from a portable terminal will be abbreviated to a “portable viewing user” below.)

The user that uploaded the image data from the user PC 102A to the photo site 105 via the Internet 104 notifies the photo site 105, by way of a Web browser, of attribute information, such as the name of the portable viewing user allowed to view images by the uploading user, and of the mail address of the portable viewing user. In response, the photo site 105 first generates the URL, which is necessary for disclosure, if an image or album is to be disclosed to the portable viewing user.

The photo site 105 reports the generated random URL to a portable terminal 113A of the portable viewing user by mail upon appending password information, which is required for viewing, if necessary. The route for transfer of mail communicated to the portable viewing user starts with the mail server of the photo site 105. The mail is sent from this server to a mobile network 114A that is capable of exchanging various data with the portable terminal 113A via an Internet connection gateway 115A connected to the Internet 104, and the mail is then transferred from the mobile network 114A to the portable terminal 113A.

Upon receiving the mail from the photo site 105, the portable viewing user employs the browser of the portable terminal 113A to enter the random URL of which it has been notified by mail, whereby the photo site 105 is accessed via the mobile network 114A, Internet connection gateway 115A and Internet 104 in the order mentioned.

The photo site 105 possesses browser information, which is exclusively for the portable terminal, created in a description language such as WML or Compact HTML exclusively for the portable terminal. This information is separate from that of the Web information created in description language such as HTML or XML displayable over the Internet 104. The photo site 105 also has image data resized so as to be displayable by the portable terminal 113A. In response to a request from the portable terminal 113A, the photo site 105 discriminates the terminal model and sends information that can be displayed by the portable terminal 113A.

Browser information of a variety of formats is available at the photo site 105 so that service can be received not only by the portable terminal 113A but also by a portable terminal 113B that has different communication protocol specifications and a different information description language and mobile network environment. Though only two utilizable portable terminals, namely 113A and 113B, are illustrated in order to simplify the drawings, it goes without saying that more than two portable terminals may be provided.

The viewing request from the portable terminal 113B is sent from a mobile network 114B, which can be utilized by the portable terminal 113B, to an Internet connection gateway 115B. Here a protocol conversion is made before the request is delivered to the photo site 105 connected to the Internet 104.

The photo site 105 possesses browser information created in a description language such as WML or Compact HTML exclusively for the portable terminal. This information is separate from that of the Web display information created in description language such as HTML or XML viewable over the Internet 104. The image data at the photo site 105 is resized so as to be viewable at the portable terminal 113B. In response to a request from the portable terminal 113B, the photo site 105 discriminates the terminal model and sends information that can be viewed at the portable terminal 113B.

Described next will be a method whereby a portable viewing user, which is a user of the portable terminal 113A or 113B, selects an image represented by image data and orders printing of an image. The information transmission path between the photo site 105 and portable terminal 113 described below is photo site 105, Internet 104, Internet connection gateway 115, mobile network 114 and portable terminal 113 in the order mentioned.

First, the portable viewing user enters a random URL of which it has been notified by mail to the browser of the portable terminal, whereby an image or album specified by the user that uploaded the images can be viewed. The portable viewing user then selects the print site, from among the print sites 109A, 109B, 109C provided by the photo site 105, to which the portable viewing user wishes to place an order. The portable viewing user selects the desired print site 109 upon taking into consideration the services, prices and delivery times, etc., provided by each of the print sites.

For the sake of simplicity, the description rendered below will assume that the portable viewing user has selected print site 109C. However, the basic flow of information is the same even if the print site selected by the portable viewing user is print site 109A or 109B.

Using the viewing screen, the portable viewing user selects the image for which printout is desired and notifies the photo site 105, whereupon the photo site 105 generates a provisional print order relating to the image requested for printout and transmits the provisional order data via the Internet 104, thereby requesting the print site 109C for an estimate. Upon receiving the provisional order from the photo site 105, the print site 109C acquires image data necessary for the selection image information from the image database 117 of photo site 105 and generates the selection image information. The print site 109C transmits the selection image information to the portable terminal 113A via the Internet 104, whereby the portable viewing user is capable of entering the print format and number of prints of every selected image at the portable terminal 113A.

On the basis of information such as the print format and number of printed for each selected image, the print site 109C calculates an estimate by a second billing module 110C and transmits the calculated estimate to the photo site 105 via the Internet 104. The photo site 105 receives the estimate information, which is transmitted from the print site 109C, in real time. If the portable viewing user is one not possessing the personal information of the user, the estimate that has been transmitted from the print site 109C is transferred to the portable terminal 113A as Web information. If the portable viewing user is one possessing the personal information of the user, then a presentation price obtained by adding points to the estimate is transferred as Web information and this can be presented dynamically to the portable viewing user that ordered printout.

The portable viewing user of the portable terminal 113A that ordered printout checks the price presented. If the portable viewing user decides to make the purchase at this price, then the portable viewing user replies to the photo site 105 in the affirmative. The settlement module 107 serving as settlement means accepts this reply and executes settlement. At the stage where settlement is concluded, the photo site 105 sends a formal print order to the print site 109C. The latter accepts the formal print order and acquires the image data necessary for printout from the image database 117 of the photo site 105.

The image represented by the image data thus acquired is printed out by a printer 111C serving as printing means possessed by the print site 109C, whereby the image is output as a print 112C. The print 112C obtained by printout is sent by transport means such as postal mail to a delivery destination specified by the user of the portable terminal 113A that requested printout.

The foregoing is an overview of an information providing system in which a third party that has received permission to view an image or album from a user that uploaded the image data views and orders the printing of images represented by the image data based upon information received from the photo site 105.

Described next will be the details of a service afforded by an information providing system in which notification of a method of viewing disclosed digital images and of comments entered by a user can be given easily without requiring that a user consider the relationship between the user and the notified destinations and the mail addresses of these destinations.

It should be noted that the services and functions implemented by the system of this embodiment are not limited to those mentioned in the overview described above.

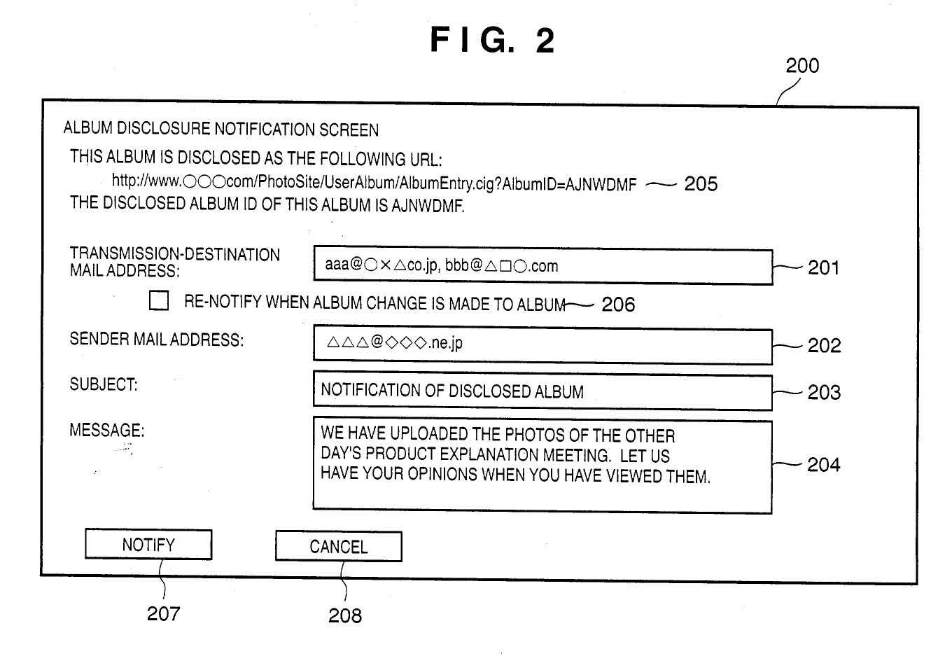

FIG. 2 is a diagram illustrating an input screen for giving notification of a viewing method according to this embodiment.

A screen 200 shown in FIG. 2 is an input screen for reporting a viewing method to a viewing user allowed to view images by a user that has uploaded the image data of these images to the photo site 105 in this embodiment. The input screen 200 is sent from the photo site 105 to the user PC and is displayed by a Web browser.

As shown in FIG. 2, the input screen 200 has an area (transmission-destination mail address) 201 for entering the E-mail addresses of viewing users allowed to view images by the uploading user; an area (sender mail address) 202 for entering the E-mail address of the user that uploaded the image data to the photo site 105; an area (subject) 203 for entering the subject of the mail to be sent; an area (message) 204 for entering comments desired to be reported in addition to the method of viewing the images represented by the image data; an area 205 that displays information relating to the method of viewing images; a check box 206 for setting whether or not re-notification is to be given when a change is made to an album subsequently; a notify button 207 for commanding start of notification by mail; and a cancel button 208 for canceling mail notification.

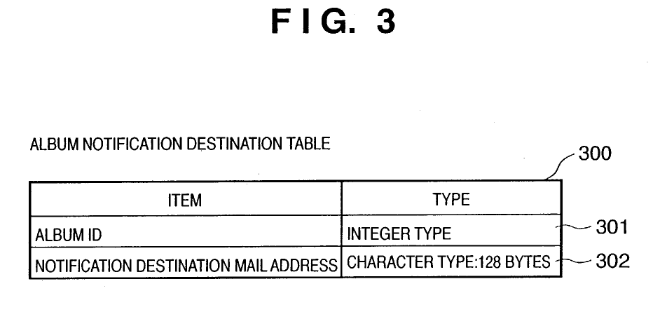

FIG. 3 is a diagram illustrating the composition of an album notification destination table 300 according to this embodiment. The album notification destination table 300 is stored in the image database 117 of the photo site 105. The album notification destination table 300 has an area 301 for storing the ID of an album that the user has disclosed, and an area 302 for storing the mail address of a third party that has been notified of the fact that the user disclosed the album of the album ID area 301. In a case where mail has been sent to a plurality of third parties in regard to a single album, a plurality of tables in which the same album ID is placed in the album ID area 301 are created. The mail address to be notified in notification processing (described later) is retrieved from the table in which the album ID area 301 has the album ID of which notification is to be given.

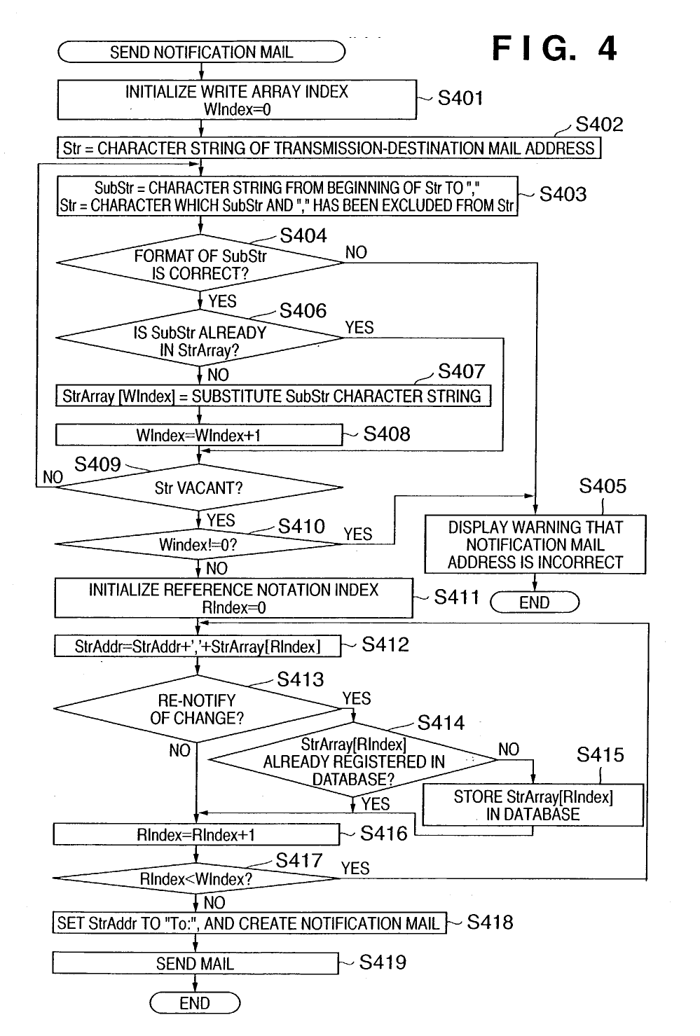

FIG. 4 is a flowchart of processing for transmitting notification mail according to this embodiment. This processing is executed by the photo site 105 when the notify button 207 shown in FIG. 2 is clicked.

First, at step S401, the photo site 105 analyzes the E-mail addresses that have been entered in the input area 201 shown in FIG. 2 and initializes an index WIndex to an array StrArray that temporarily holds the separately disassembled mail addresses. Next, at step S402, the E-mail addresses that have been entered in the input area 201 shown in FIG. 2 are copied to an analysis area Str for analysis. This is followed by step S403, at which a mail address, which is delimited by the commas “,”, is extracted from the character string in the analysis area Str and copied to a temporary area SubStr. Further, in order to extract a succeeding mail address from this mail address that has been extracted, the character string that has been copied from the character string of the analysis area Str to the temporary area SubStr and, if there is a delimiter character, a character string from which this delimiter has been excluded are preserved anew in the analysis area Str.

It should be noted that delimiting of entered mail addresses is not limited to the above. For example, a symbol such as “;” other than symbols representing a mail address can be used as a delimiter for mail addresses.

Next, at step S404, in accordance with an RFC (Request For Comment), which is a document formally issued by the IETF (Internet Engineering Task Force) [an organization under the ISOC (Internet SOCiety)], the photo site 105 determines whether the character string in the area SubStr indicates a mail address. If the character string does indicate a mail address, control proceeds to step S406; otherwise, control proceeds to step S405, at which the photo site 105 displays a warning to the effect that the transmission-destination mail address is incorrect and terminates processing.

The photo site 105 checks to determine whether the character string in the temporary area SubStr already exists in the array StrArray a step S406. If the character string does exist in the array, control proceeds to step S409; otherwise, control proceeds to step S407, where the character string in temporary area SubStr to which the transmission-destination mail address has been copied is copied to the array StrArray that the index WIndex indicates. The index WIndex is counted up at step S408.

Next, at step S409, the photo site 105 checks to determine whether the character string of the mail address already exists in the analysis area Str. If the character string does exist in the analysis area Str, control returns to step S403, the photo site 105 extracts the next mail address and then repeats the above processing. If the character string does not exist in the analysis area Str, control proceeds to step S410, where the photo site 105 determines, depending upon whether the index WIndex is “0” or not, the number of mail addresses stored in the array StrArray. If there are no stored mail addresses, control proceeds to step S405, where the photo site 105 commands the Web browser to display a message to the effect that the characters include a character string not determined to be a mail address or that a mail address has not been entered. Processing is then exited.

If it is found at step S410 that a mail address has been stored, control proceeds to step S411, where the photo site 105 initializes an index RIndex, which is for referring to the array StrArray holding the mail address. Next, at step S412, the photo site 105 creates a character string StrAddr for using a plurality of addresses as destinations. It should be noted that the address delimiter “,” is not added on if index RIndex is index WIndex−1, though this is not illustrated. This is followed by step S413, at which the photo site 105 determines whether the present notification destination is to be re-notified. If the check box 206 on screen 200 shown in FIG. 2 has been checked, the photo site 105 construes re-notification and control proceeds to step S414. If the check box 206 on screen 200 has not been checked, the photo site 105 does not construe re-notification and control proceeds to step S416.

At step S414, the photo site 105 retrieves, from the album notification destination table 300 in the image database 117, all records in which the album ID area 301 has an album ID for which notification is to be given at the present time, and determines whether a character string the same as that of the mail address in the array StrArray indicated by the index RIndex has already been registered in the area 302 for the notification-destination mail address. If such a character string has been registered, control proceeds to step S416; otherwise, control proceeds to step S415. Here the photo site 105 creates a new record in which the album notification destination table 300 of image database 117 has, in the album ID area 301, the album ID for which notification is to be given and, in the area 302 for the notification-destination mail address, the mail address in the array StrArray indicated by the index RIndex. The photo site 105 increments index RIndex at step S416 and, at step S417, checks to determine whether another mail address is present in the array StrArray indicated by index RIndex. If another mail address is present, then control returns to step S412, where the photo site 105 repeats the above processing.

If it is found at step S417 that another mail address does not exist in the array StrArray indicated by index RIndex, control proceeds to step S418. Here the photo site 105 adopts the mail address that has been registered in the character string StrAddr as the destination (to:) and creates notification mail using the information that has been entered in the input areas 202 to 204, shown in FIG. 2, and the viewing method displayed in the information display area 205. Then, at step S419, the photo site 105 transmits the notification mail created at step S418 and terminates processing.

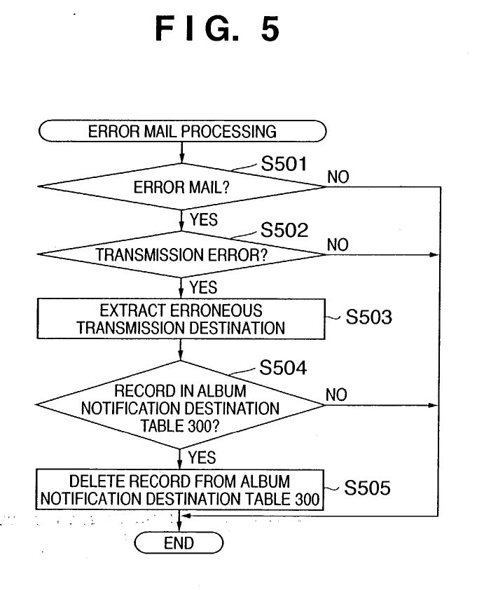

FIG. 5 is a flowchart of error-mail processing according to this embodiment. This is processing executed by the photo site 105 when the photo site 105 has received error mail from the Internet 104.

First, at step S501, the photo site 105 determines whether error mail has been received from the Internet 104. If there is no error mail, processing is exited. If there is error mail, however, control proceeds to step S502, where the photo site 105 determines whether the error mail is an error relating to mail transmission. If the error is not a mail transmission error, processing is exited. If the error is a mail transmission error, however, control proceeds to step S503, where the mail address of the transmission destination involving the mail transmission error is extracted from the error mail.

Next, at step S504, the photo site 105 retrieves, from the album notification destination table 300 in image database 117, all records in which area 302 for the notification-destination mail address has the mail address extracted at step S503. If such records do not exist, processing is terminated. If such a record exists, however, control proceeds to step S505, where the photo site 105 deletes all records retrieved at step S504 and terminates processing.

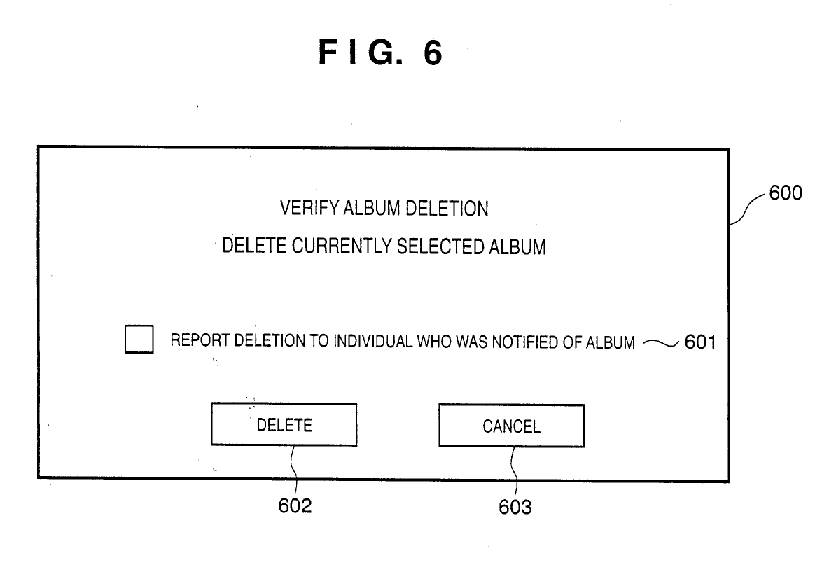

FIG. 6 is a diagram illustrating a screen 600 for verifying album deletion. The verification screen 600 shown in FIG. 6 is displayed when the user browses the photo site 105, selects a disclosed album and deletes this image data. Further, the verification screen 600 has a check box 601 for setting whether a third party that has been notified of disclosure of an album is to be notified of deletion, a delete button 602 for executing deletion, and a cancel button 603 for canceling deletion.

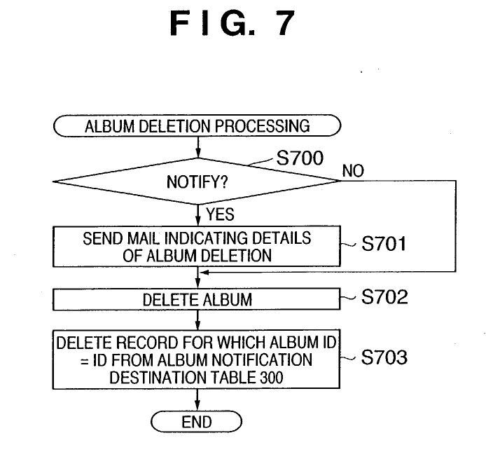

FIG. 7 is a flowchart of album deletion processing according to this embodiment. This processing is executed by the photo site 105 when the delete button 602 is clicked on the album-deletion verification screen 600.

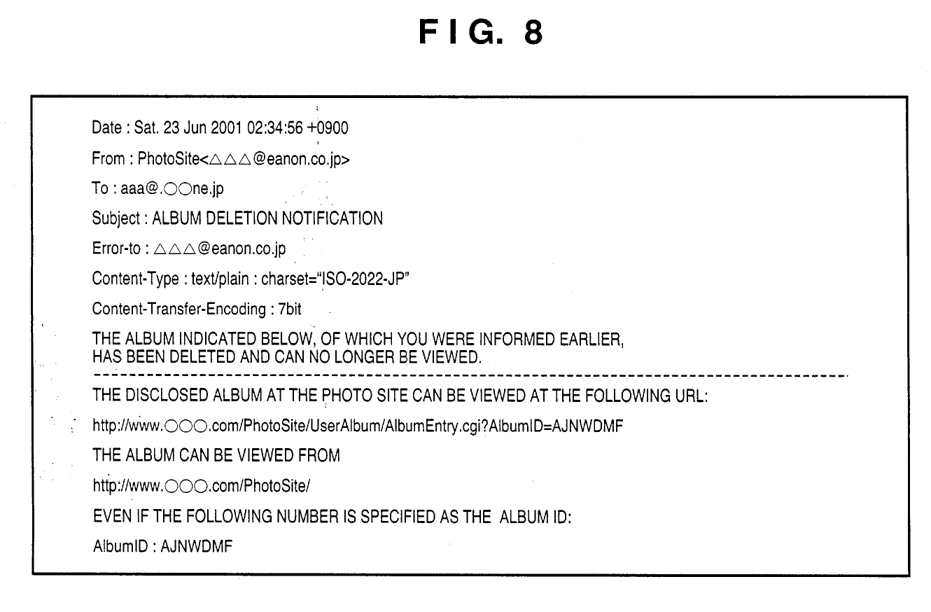

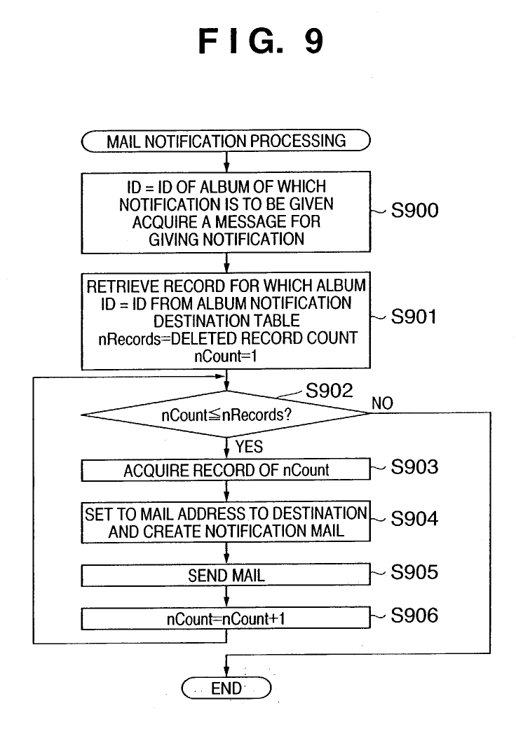

First, if the photo site 105 determines at step S700 that the check box 601 has not been checked on the album-deletion verification screen 600, control proceeds to step S702. If the check box 601 has been checked, control proceeds to step S701, where the photo site 105 reports to notification processing (described later with reference to FIG. 9) the ID of the album that is to be deleted at the present time and a notification message, and communicates mail indicating the details of album deletion. FIG. 8 is a diagram illustrating an example of mail, which notifies of album deletion, transmitted by notification processing.

Next, at step S702, the photo site 105 deletes the album image data and the album. This is followed by step S703, at which the photo site 105 deletes, from the image database 117, the record for which the album ID to be deleted has been set in the album ID area 301 of the album notification destination table 300.

FIG. 9 is a flowchart of mail notification processing according to this embodiment. This processing is executed by the photo site 105 when an album is deleted, an album is made private and an album is re-disclosed.

First, at step S900, the photo site 105 acquires the ID of an album for which notification of album deletion, restoration of album privacy or album re-disclosure is to be given, and a message for giving notification. Next, at step S901, the photo site 105 retrieves, from the album notification destination table 300 in image database 117, records for which the album ID, acquired at step S900, has been set in the album ID area 301. Further, at step S901, the photo site 105 substitutes the number of retrieved records in a record count nRecords based upon the retrieved results and sets “1” in a job variable nCount that counts the number of records to be processed.

Next, at step S902, the photo site 105 determines whether the job variable nCount is equal to or less than record count nRecords. Control proceeds to step S903 for as long as the job variable nCount is equal to or less than the record count nRecords. If the job variable nCount exceeds the record count nRecords, processing is terminated. At step S903, the photo site 105 acquires the retrieved record indicated by the job variable nCount. Next, at step S904, the photo site 105 acquires the notification-destination mail address 302 from this retrieved record and creates notification mail in which this mail address is set as the destination. Then, at step S905, the photo site 105 transmits the mail created at step S904. This is followed by step S906, at which the photo site 105 increments the job variable nCount. Control then returns to step S902 and the photo site 105 repeats the above processing.

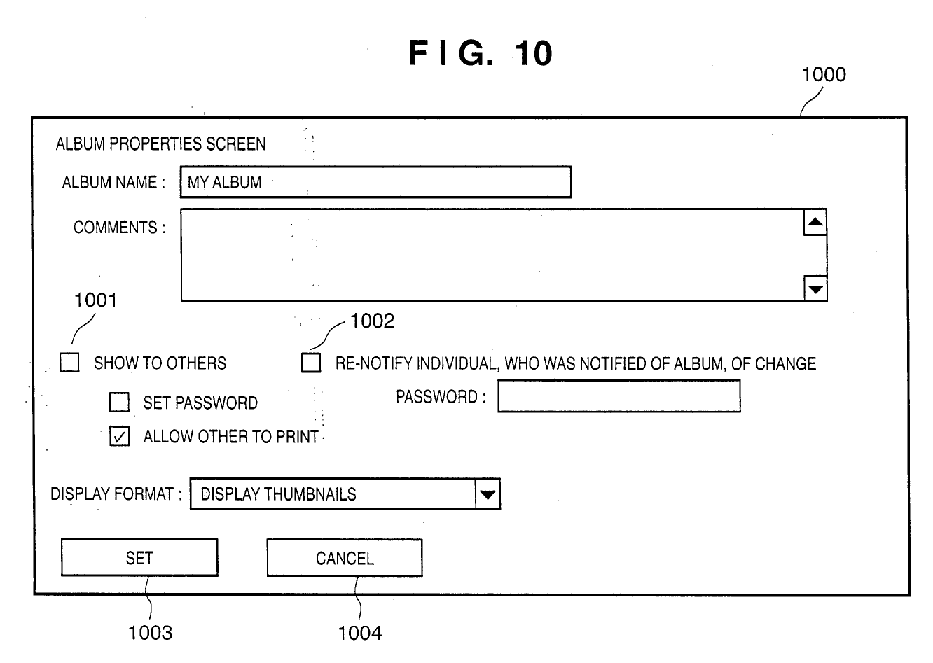

FIG. 10 is a diagram illustrating a screen 1000 of album properties according to this embodiment. The properties screen 1000 is displayed when album properties are set. A check box 1001 is for indicating whether disclosure to a third party is to be made possible. The album can be viewed by the third party only if the check box 1001 is checked.

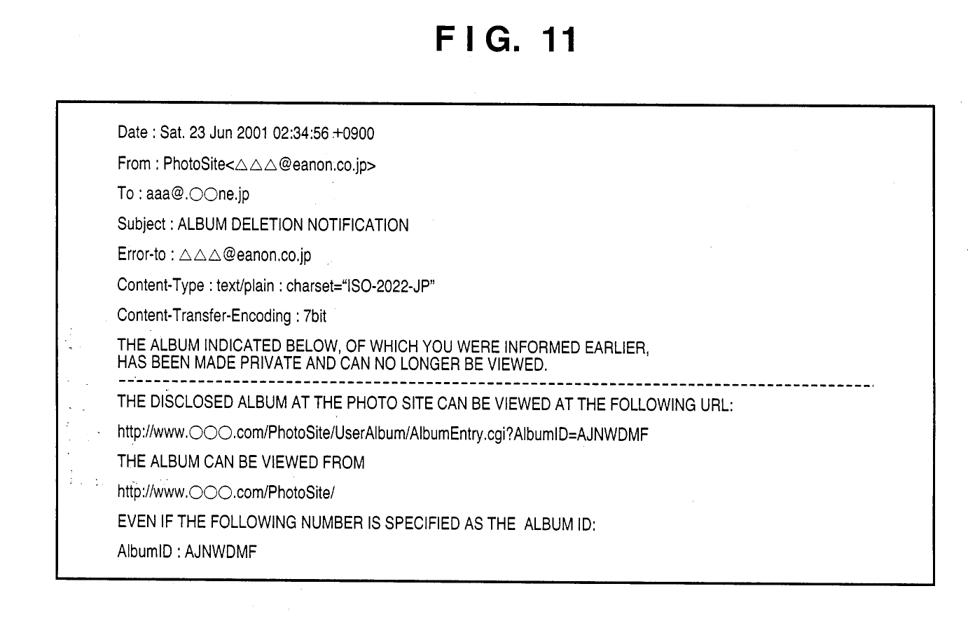

A check box 1002 is for deciding whether a person who was notified of disclosure of the album in the past is to be re-notified when the setting in check box 1001 has been changed. For example, if check box 1002 has been checked, a check in the check box 1001 is removed and a set button 1003 is clicked, then the third party is notified that viewing of the album will no longer be possible. In this case, the photo site 105 creates mail of the kind shown in FIG. 11 automatically by the notification processing of FIG. 9 and transmits this as mail notifying that the album is no longer disclosed.

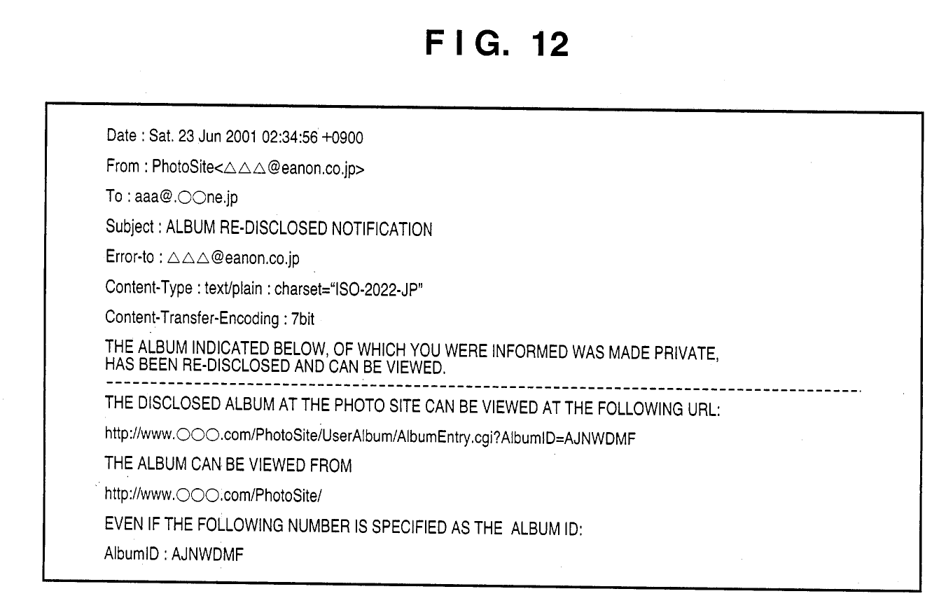

Further, if the check box 1002 has been checked, the check box 1001 is checked and the set button 1003 is clicked, then the third party is notified that viewing of the album is again possible. In this case, the photo site 105 creates mail of the kind shown in FIG. 12 automatically by the notification processing of FIG. 9 and transmits this as mail notifying that the album has been disclosed again.

Thus, the embodiment described above is such that when notification of disclosure of an album is given, whether or not notification of a subsequent change is to be given is set. This makes it possible for the user to notify of image deletion or of a change in view setting without the user needing to be aware of whom was notified in the past. Thus the user can notify a third party of the operation performed by user without a great burden being imposed upon the user.

The embodiment described above is such that when notification of disclosure of data is given, whether or not a plurality of third parties are to be notified of a change in viewing after disclosure is designated, thereby making it possible to reliably notify a plurality of third parties of a change in viewing of the data.

Further, the burden upon the user that uploaded the data can be alleviated, thereby enhancing user convenience.

[Modification]

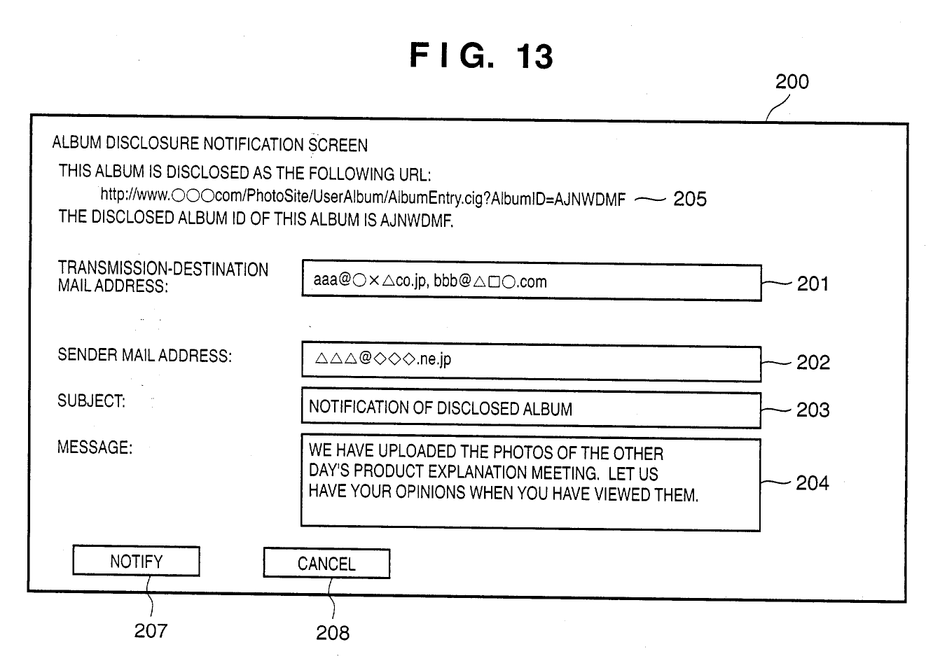

In the above embodiment, the check box 206 of the album disclosure notification screen shown in FIG. 2 is checked when the user uploads data from the user PC to the photo site 105 and the data is disclosed to a third party that the user has allowed to view the data, whereby the user designates re-notification when a change is made to an album after disclosure. However, as shown in FIG. 13, it is permissible to adopt an arrangement in which the check box 206 is not provided, a plurality of third parties that have been entered in the area 201 for transmission-destination mail addresses are stored unconditionally together with identification information that identifies the data, and the stored third parties are re-notified of data deletion or of a change in view setting if viewing of the data has been changed after disclosure.

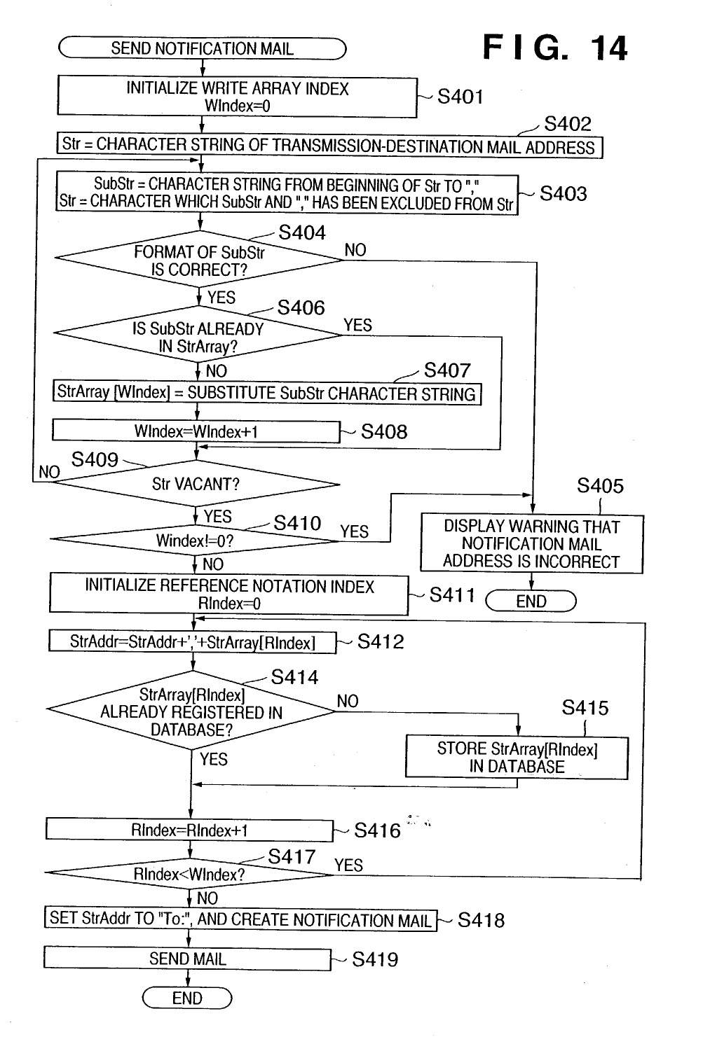

FIG. 14 is a flowchart of processing for transmitting notification mail according to the modification. Steps in the flowchart of FIG. 14 that are identical with those of the processing for transmitting notification mail in FIG. 4 are designated by like step numbers.

In this modification, as shown in FIG. 14, the photo site 105 initializes the index RIndex, which is for referring to the array StrArray holding the mail address, at step S411. Next, at step S412, the photo site 105 creates the character string for using a plurality of addresses as destinations. Control then proceeds to step S414 unconditionally. Here the photo site 105 retrieves, from the album notification destination table 300 in the image database 117, all records in which the album ID area 301 has an album ID for which notification is to be given at the present time, and determines whether a character string the same as that of the mail address in the array StrArray indicated by the index RIndex has already been registered in the area 302 for the notification-destination mail address.

In accordance with this modification, address information of a plurality third parties allowed to view data is managed together with identification information that identifies the data, whereby a change in viewing can be reported reliably to the plurality of third parties.

It may be so arranged that when an album is disclosed, a selection can be made as to whether or not to provide a setting to designate, or not to designate, re-notification on an album-by-album basis when a change is made to the album after it has been disclosed.

[Other Embodiments]

In the above embodiment, an album, which is a collection of image data, is treated as the unit of disclosure. However, in a case where an individual image is the unit of disclosure, this can be dealt with easily by adopting the album ID 301 in the album notification destination table 300 of FIG. 3 as the image data ID and linking it to the image data.

Further, in the foregoing embodiment, a case in which an album, which is a collection of image data, is disclosed is described. However, it is obvious that the invention can be applied in similar fashion even with regard to a case where an album includes image data, document data or a combination of image data and document data.

Furthermore, it goes without saying that the object of the invention is attained also by supplying a recording medium (or storage medium) storing the program codes of the software for performing the functions of the foregoing embodiments to a system or an apparatus, reading the program codes with a computer (e.g., a CPU or MPU) of the system or apparatus from the storage medium, and then executing the program codes. In this case, the program codes per se read from the storage medium implement the novel functions of the embodiments and the recording medium on which the program codes have been recorded constitutes the invention. Furthermore, besides the case where the aforesaid functions according to the embodiments are implemented by executing the program codes read by a computer, it goes without saying that the present invention covers a case where an operating system or the like running on the computer performs a part of or the entire process in accordance with the designation of program codes and implements the functions according to the embodiment.

It goes without saying that the present invention further covers a case where, after the program codes read from the recording medium are written to a function expansion card inserted into the computer or to a memory provided in a function expansion unit connected to the computer, a CPU or the like contained in the function expansion card or function expansion unit performs a part of or the entire actual process in accordance with the designation of program codes and implements the functions of the above embodiments.

In a case where the present invention is applied to the above-described storage medium, program codes corresponding to the flowcharts described earlier are stored on this storage medium.

As many apparently widely different embodiments of the present invention can be made without departing from the spirit and scope thereof, it is to be understood that the invention is not limited to the specific embodiments thereof except as defined in the appended claims.

What is claimed is:

1. An information providing system for providing a service for storing data and disclosing the stored data on a network by using a plurality of information processing apparatuses, the system including the plurality of information apparatuses, said system comprising:
first notification means for notifying designated external communication terminals of the fact that disclosure of the stored data is possible;
determination means for determining whether or not to notify the designated external communication terminals of a change if the data has been changed or a setting of disclosing the data has been changed after notification by said first notification means;
detection means for detecting whether or not the data has been changed or the setting of disclosing the data has been changed; and
second notification means for notifying the designated external communication terminals of the change in accordance with determination of the notification by said determination means and detection of the change by said detection means.

2. The system according to claim 1, further comprising means for sending, to an external communication terminal which is operated by an owner of the data, page data for displaying a screen for inputting the determination of the notification on the external communication terminal, via the network.

3. The system according to claim 1, wherein the data has been uploaded from an external communication terminal, which is operated by an owner of the data, via the network.

4. The system according to claim 1, wherein said second notification means notifies the designated external communication terminals of the fact that disclosure of the stored data is impossible if the notification has been executed by said first notification means and it has been detected that the data has been deleted or the setting of disclosing the data has been changed to nondisclosure by said detection means.

5. The system according to claim 1, wherein said second notification means notifies the designated external communication terminals of the fact that disclosure of the data is impossible if the notification has been executed by said first notification means and it has been detected that the data has been deleted or the setting of disclosing the data has been changed to the disclosure impossible by said detection means, and
further comprising third notification means for notifying the designated external communication terminals of the fact that disclosure of the data is possible if the notification has been executed by said second notification means and it has been detected that the setting of disclosing the data has been re-changed from the disclosure impossible to the disclosure possible by said detection means.

6. The system according to claim 5, wherein said first, second or third notification means foregoes notifying an external communication terminal involved in notification error from among the designated external communication terminals.

7. The system according to claim 1, wherein the data is at least one of image data, document data or an album composed of a plurality of items of image data.

8. The system according to claim 5, further comprising management means for managing the data and data identification information for uniquely identifying the data,
wherein said first, second or third notification means executes the notification together with the data identification information managed by said management means.

9. The system according to claim 5, further comprising management means for managing address information of the designated external communication terminals,
wherein said first, second or third notification means executes the notification based on the address information managed by said management means.

10. An information providing method of providing a service for storing data and disclosing the stored data on a network, the method being implemented by the plurality of information processing apparatuses, said method comprising:
a first notification step of notifying designated external communication terminals of the fact that disclosure of the stored data is possible;
a determination step of determining whether or not to notify the designated external communication terminals of a change if the data has been changed or a setting of disclosing the data has been changed after notification of the change;
a detection step of detecting whether or not the data has been changed or the setting of disclosing the data has been changed; and
a second notification step of notifying the designated external communication terminals of the change in accordance with determination of the notification and detection of the change.

11. A program for implementing the information providing method set forth in claim 10.

12. A computer-readable recording medium storing the program set forth in claim 11.

13. An information providing apparatus for providing a service for storing data and disclosing the stored data on a network, comprising:
first notification means for notifying designated external communication terminals of the fact that disclosure of the stored data is possible;
determination means for determining whether or not to notify the designated external communication terminals of a change if the data has been changed or a setting of disclosing the data has been changed after notification of the change by said first notification means;
detection means for detecting whether or not the data has been changed or the setting of disclosing the data has been changed; and
second notification means for notifying the designated external communication terminals of the change in accordance with determination of the notification by said determination means and detection of the change by said detection means.
